(19) United States
(12) Patent Application Publication
(10) Pub. No.: US 2023/0335313 A1
(43) Pub. Date: Oct. 19, 2023

(54) METAL CLAD CABLE ASSEMBLY

(71) Applicant: Cerro Wire LLC, Hartselle, AL (US)

(72) Inventor: Jon Kopfer, Huntsville, AL (US)

(21) Appl. No.: 17/673,901

(22) Filed: Feb. 17, 2022

(51) Int. Cl. H01B 9/02; H01B 9/00; H01B 7/02

(52) U.S. Cl. CPC H01B 9/028; H01B 7/02; H01B 9/006

(57) ABSTRACT

A metal clad cable includes two or more power conductors each disposed within a first jacket and a binder surrounding the at least two power conductors, The binder is loosely positioned around the power conductors. The cable can include a bare grounding/bonding wire. The cable includes a spiral wound metal cladding surrounding the power conductors and the bare grounding/bonding wire. The cable can include a control subassembly and a binder surrounding the power conductors. The power conductors can also be individually disposed within their respective binders.

### BACKGROUND

The present disclosure relates generally to a metal clad cable, and more particularly, to a metal clad cable that may include a bare grounding/bonding wire and/or a loosely wound binder, and/or a control subassembly.

Metal clad cable has a spiral wound, interlocked metal cladding or armor that provides a low impedance ground path or grounding conductor for equipment. The cladding or armor is spiral wound with edges interlocking adjacent edges that also provides continuous protection for the wires within the cladding. A typical metal clad (MC) cable can include power conductors, an insulated grounding conductor and/or bare grounding/bonding wire, signal or control conductors and the like. The conductors can be twisted (also referred to as cabled) wires and separate from the twisted wires, a bare conductor that serves as a ground. It is important that the bare grounding/bonding conductor is in continuous contact with the metal cladding to provide an adequate ground path.

A way in which the bare grounding/bonding wire is maintained in contact with the metal cladding is by tightly wrapping a binder/tape around the conductors and positioning the bonding wire outside of the wrap, between the wrap and the cladding. The pressure applied by the tight wrap on the bonding wire forces the bonding wire into contact with the cladding.

One drawback to the tight wrap arrangement is that the wrapping material can tear or break and as a result, the necessary wrap around the conductors may be compromised. In addition, specialized equipment may be needed to perform the wrap, which equipment may increase costs in manufacture of the cable. Another drawback to the tight wrap arrangement is that it may be difficult to flatten the tightly wrapped wires so that the product specifications and markings printed on the tape can be read.

Accordingly, it is desirable to provide a metal clad cable that is readily manufactured, meets required codes, and in some embodiments, does not require maintaining a specific tension on any wrap materials during manufacture.

### SUMMARY

According to one embodiment, a metal clad cable includes at least two power conductors each disposed within a first jacket, a bare grounding/bonding wire, a binder or separator material, for example, a wrap surrounding and loosely positioned around the at least two power conductors, and a spiral wound metal cladding surrounding the wrapped power conductors and the bare grounding/bonding wire.

The bare grounding/bonding wire is positioned between the binder and the spiral wound metal cladding and is in continuous contact with the spiral wound metal cladding. The bare grounding/bonding wire is maintained in continuous contact with the spiral wound metal cladding by a force applied by at least one of the at least two power conductors on the bare grounding/bonding wire.

In embodiments, the binder is a polymeric material, such as a polyester or polyethylene material. A polyester material can be, for example, a polyester tape. One suitable polyester material is MYLAR®.

In an embodiment, the cable includes three power conductors. The binder is loosely positioned around the three power conductors, and the bare grounding/bonding wire is outside of the binder, between the binder and the spiral wound metal cladding. The cable can include an insulated grounding conductor.

In embodiments, power conductors are 10 gauge or 12 gauge or 14 gauge conductors and the bare grounding/bonding wire is an 8 gauge or 10 gauge or 12 gauge conductor. The power conductors can be solid conductors or they can be stranded conductors.

In another aspect, a metal clad cable includes at least two power conductors each disposed within a first jacket, a bare grounding/bonding wire, a binder surrounding each of the power conductors and a spiral wound metal cladding surrounding each of the wrapped power conductors and the bare grounding/bonding wire.

The bare grounding/bonding wire is positioned between the wrapped power conductors and the spiral wound metal cladding and is in continuous contact with the spiral wound metal cladding. The grounding/bonding wire is maintained in continuous contact with the spiral wound metal cladding by a force applied by at least one of the at least two power conductors on the bare grounding/bonding wire. In embodiments, the binder is a polymeric material such as a polyester or a polyethylene material. A polyester material can be, for example, a polyester tape. One suitable polyester material is MYLAR®.

In embodiments, the cable includes three power conductors, each of the three power conductors being individually wrapped with, for example, the MYLAR® tape. The bare grounding/bonding wire is positioned between the binder of one or more of the three wrapped power conductors and the spiral wound metal cladding.

In embodiments, the power conductors are 10 gauge or 12 gauge or 14 gauge conductors and bare grounding/bonding wire is an 8 gauge or 10 gauge or 12 gauge conductor. The power conductors can be solid conductors or stranded conductors. The cable can include an insulated grounding conductor.

In another aspect a metal clad cable includes at least two power conductors each disposed within a first jacket, a control subassembly comprising at least two control wires, each of the at least two control wires disposed in a second jacket, a binder surrounding the at least two power conductors, and a spiral wound metal cladding surrounding the wrapped at least two power conductors and the wrapped control subassembly. The control subassembly may be contained with still another jacket.

In embodiments, the first binder is a polymeric material, such as a polyester or a polyethylene material. A polyester material can be, for example, a polyester tape. One suitable polyester material is MYLAR®. In embodiments, the cable further includes a second binder surrounding the wrapped power conductors and the control subassembly. In embodiments, the cable includes three power conductors. In embodiments, the second binder surrounds the wrapped three power conductors and the control subassembly.

In embodiments, the power conductors are 10 gauge or 12 gauge conductors and the control conductors are 16 gauge conductors. The conductors can be solid conductors or stranded conductors. The cable can include an insulated grounding conductor.

In still another aspect, a metal clad cable includes at least two power conductors each disposed within a first jacket, a control subassembly comprising at least two control wires, each of the at least two control wires disposed in a second jacket, a binder surrounding each of the at least two power conductors, and a spiral wound metal cladding surrounding the wrapped at least two power conductors and the control subassembly.

In embodiments, the first binder is a polymeric material, such as a polyester or a polyethylene material. A polyester material can be, for example, a polyester tape. One suitable polyester material is a MYLAR® tape. The cable can include three power conductors, each of the power conductors being individually wrapped with the MYLAR® tape. The cable can further include a second binder surrounding the wrapped power conductors and the control subassembly.

The power conductors can be 10 gauge or 12 gauge conductors and the control conductors are 16 gauge conductors. The two power conductors can be solid conductors or stranded conductors. The cable can include an insulated grounding conductor.

These and other features and advantages of the present invention will be apparent from the following detailed description, in conjunction with the appended claims.

### BRIEF DESCRIPTION OF THE DRAWINGS

FIG. 1 is a perspective illustration of an example of a metal clad cable according to an embodiment described herein;

FIG. 2 is a perspective illustration of an example of a metal clad cable according to another embodiment described herein;

FIG. 3 is a perspective illustration of an example of a metal clad cable according to still another embodiment described herein;

FIG. 4 is a perspective illustration of an example of a metal clad cable according to yet another embodiment described herein;

FIGS. 5 and 5A are perspective and cross-sectional illustrations of an example of a metal clad cable according to still another embodiment described herein;

FIGS. 6 and 6A are perspective and cross-sectional illustrations of an example of a metal clad cable according to still another embodiment described herein;

FIG. 7 is a perspective illustration of an example of a metal clad cable according to still another embodiment described herein;

FIG. 8 is a perspective illustration of an example of a metal clad cable according to another embodiment described herein;

FIG. 8A is a cross-sectional view of the cable of FIG. 8; and

FIGS. 8B-8D are cross-sectional views of alternate metal clad cables similar to the cable of FIGS. 8 and 8A.

### DETAILED DESCRIPTION

While the present device is susceptible of embodiment in various forms, there is shown in the figures and will hereinafter be described a presently preferred embodiment with the understanding that the present disclosure is to be considered an exemplification of the device and is not intended to be limited to the specific embodiment illustrated.

Disclosed are various embodiments of a metal clad cable 10. The illustrated cables include an outer cladding 12, insulated conductors 14, and a wrap or binder tape 16. As detailed below certain of the embodiments include one or more of an insulated grounding conductor 18, a bare grounding/bonding wire 20, and control conductors 22. In some embodiments, the cable includes a marker tape 24.

For purposes of the present disclosure, each of the power conductors and the insulated grounding conductor discussed below are insulated or jacketed, the insulation or jacket being indicated by the same reference number as its conductor, followed by the letter “a”. For example, where discussed, power conductor 14 includes insulator or jacket 14a. This nomenclature applies to all disclosed embodiments and further applies to control conductors 22 (see, for example, FIG. 3).

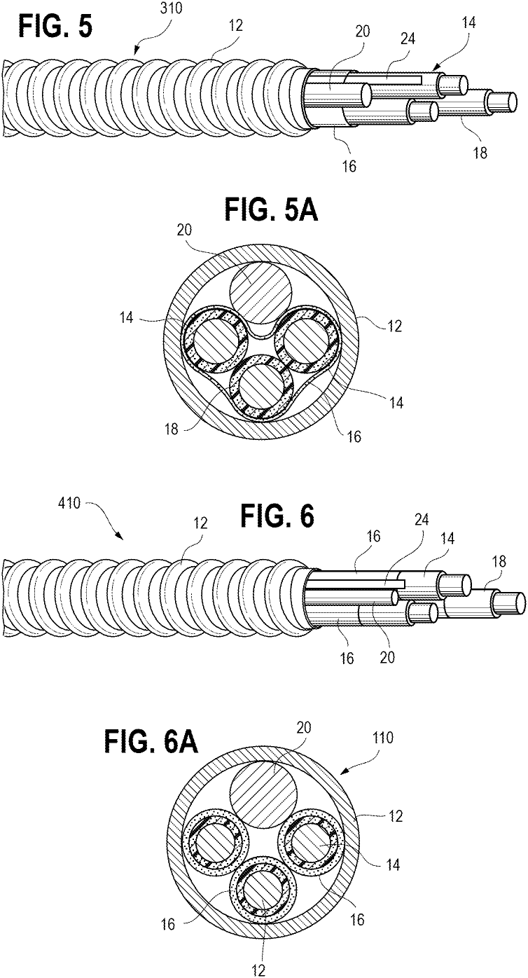

In some embodiments, such as those illustrated in FIGS. 5 and 6, the conductors 14 for example, the two power conductors and the insulated grounding conductor 18 are wrapped with the binder 16 such as a polymeric materials, such as a polyester or a polyethylene material binder. A polyester material can be, for example, a polyester tape. One suitable polyester material is a MYLAR® tape surrounding the power conductors 14 and the insulated grounding conductor 18. The binder 16 is loosely wrapped around the conductors 14, 18 so as to allow the conductors 14, 18 to freely move.

The binder 16 or separator media can be, as noted above, a tape. Tape materials can be, for example, polyester, such as MYLAR® tape. Examples of suitable polymeric material include polyethylene and polyester, polyester (MYLAR®) tapes are corrugated tapes of widths such as 1 inch, 1.25 inches, 1.5 inches, 1.75 inches and so forth. The tape can be wrapped helically around the conductors. When helically wrapped, the tape should be overlapped as wrapped around the conductors at least about ⅛ inch when applied helically. A suitable corrugated tape thickness is about 4-7 mils thick. Flat tapes are also suitable. For example, flat tapes of widths such as 1 inch, 1.25 inches, 1.5 inches, 1.75 inches and so forth can be used. The tape should be overlapped as wrapped around the conductors at least about ⅛ inch when applied helically. A suitable flat tape thickness is about 4-7 mils thick.

A suitable corrugated tape thickness is about 4-7 mils thick. Flat tapes are also suitable. For example, flat tapes of widths such as 1 inch, 1.25 inches, 1.5 inches, 1.75 inches and so forth can be used. The tape should be overlapped as wrapped around the conductors at least about ⅛ inch when applied longitudinally. A suitable flat tape thickness is about 4-7 mils thick.

As seen in the figures, the metal cladding 12 is an interlocked, spiral wound covering in which the winds, e.g., 12a, 12b, overlap and interlock with adjacent winds to form a protective covering. In embodiments, the winds are convoluted to allow the winds to flex relative to one another. This allows the cable to be pulled through conduit, wall openings and the like and to flex, to conform to bends and the like, without stressing or compromising the integrity of the conductors 14, 18, 20, 22. The metal cladding can be, for example, aluminum, galvanized steel, or the like, as allowed by applicable codes and/or standards. A suitable armor or cladding material includes, for example, an aluminum-based alloy having a copper content of 0.4 percent or less. Another suitable material is steel that is made corrosion-resistant by a coating of zinc on all surfaces (galvanized steel).

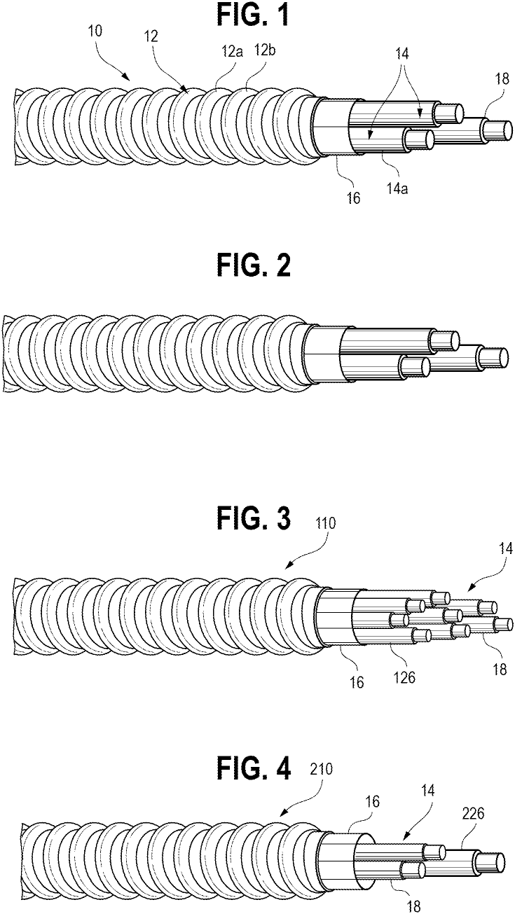

FIG. 1 illustrates a cable 10 that includes conductors 14, which can be solid or stranded conductors. The cable 10 includes a wrap or tape 16 around the conductors. The tape can be a polymeric tape, such as a polyester or a polyethylene tape, such as the polyester tape, as described above. In cables having solid conductors, the solid conductors can range from 14 AWG to 10 AWG, with the number of conductors 14 ranging from 2 to 4, and with the insulated grounding conductor 18 ranging from 14 AWG to 10 AWG as provided in Table 1, below:

TABLE 1

Standard Metal Clad (MC) Cable with Solid Conductors

| Conductors AWG/No. | Insulated Grounding Conductor (AWG) |
|---|---|
| 14/2, 14/3, 14/4 | 14 |
| 12/2, 12/3, 12/4 | 12 |
| 10/2, 10/3, 10/4 | 10 |

In cables having stranded conductors, the stranded conductors can range from 14 AWG to 2 AWG, with the number of conductors ranging from 2 to 4, and with the insulated grounding conductor ranging from 14 AWG to 6 AWG as provided in Table 2, below:

TABLE 2

Standard Metal Clad (MC) Cable with Stranded Conductors

| Conductors AWG/No. | Insulated Grounding Conductor (AWG) |
|---|---|
| 14/2, 14/3, 1 4.4 | 14 |
| 12/2, 12/3, 12/4 | 12 |
| 10/2, 10/3, 10/4 | 10 |
| 8/2, 8/3, 8/4 | 10 |
| 6/2, 6/3, 6/4 | 8 |
| 4/3, 4/4 | 8 |
| 3/3, 3/4 | 6 |
| 2/3, 2/4 | 6 |

Another cable, such as that illustrated in FIG. 2 has a similar construction to the cable illustrated in FIG. 1 and can be, for example, a fire alarm cable, and can include solid conductors ranging from 18 AWG to 12 AWG, with the number of conductors ranging from 2 to 4, and with the insulated grounding conductor ranging from 18 AWG to 12 AWG as provided in Table 3, below:

TABLE 3

Metal Clad (MC) Fire Alarm Cable

| Conductors AWG/No. | Insulated Grounding wire (AWG) |
|---|---|
| 18/2, 18/4 | 18 |
| 16/2, 16/4 | 16 |
| 14/2, 14/4 | 14 |
| 12/2, 12/3, 12/4 | 12 |

Still another cable 110, such as that illustrated in FIG. 3, includes multiple neutral conductors 126, such as a neutral conductor per phase, can include multiple phases 14 and a wrap or tape 16 around the conductors. The tape can be a polymeric tape, such as a polyester or polyethylene tape, such as the polyester tape, as described above. The conductors can be formed from solid or stranded conductors. The solid conductors can include neutral conductors per phase and an insulated grounding conductor. The phase conductors can range from 12 AWG to 10 AWG, with the number of conductors ranging from 2 to 8; neutral conductors ranging from 12 AWG to 8 AWG, the number of neutral conductors ranging from 2 to 6; and the insulated grounding conductor ranging from 12 AWG to 10 AWG as provided in Table 4, below:

TABLE 4

Neutral Per Phase MC Cable with Solid Conductors

| Conductors (AWG/No.) | Neutral conductor (AWG/No.) | Insulated Grounding Conductor (AWG/No.) |
|---|---|---|
| 12/2, 12/3 | 12/2 | 12/1 |
| 12/4 | 10/2, 12/4 | 12/1 |
| 12/6, 12/8 | 10/2 | 12/1 |
| 10/2, 10/3 | 10/2 | 10/1 |
| 10/4 | 8/2, 10/2 | 10/1 |
| 10/6 | 8/2, 10/6 | 10/1 |
| 10/8 | 8/2 | 10/1 |

The cable having neutral per phase conductors with stranded conductors can likewise include neutral conductors per phase and an insulated grounding conductor. The phase conductors can range from 12 AWG to 10 AWG, with the number of conductors ranging from 2 to 6; neutral conductors ranging from 12 AWG to 10 AWG, the number of neutral conductors ranging from 2 to 6; and the insulated grounding conductor ranging from 12 AWG to 10 AWG as provided in Table 5, below:

TABLE 5

Neutral Per Phase MC Cable with Stranded Conductors

| Conductors (AWG/No.) | Neutral conductor (AWG/No.) | Insulated Grounding Conductor (AWG/No.) |
|---|---|---|
| 12/2 | 12/2 | 12/1 |
| 12/3 | 12/3 | 12/1 |
| 12/4 | 12/4 | 12/1 |
| 10/2 | 10/2 | 10/1 |
| 10/3 | 10/3 | 10/1 |
| 10/4 | 10/2, 10/4 | 10/1 |
| 10/6 | 10/6 | 10/1 |

Another neutral conductor cable 210, similar to that illustrated in FIG. 4, can include solid or stranded conductors 14, an oversized neutral conductor 226, an insulated grounding conductor 18, and a wrap or tape 16 around the conductors. The tape can be a polymeric tape, such as a polyester or a polyethylene tape, such as the polyester tape, as described above. The cables having solid conductors can include phase conductors ranging from 12 AWG to 10 AWG, with the number of phase conductors ranging from 1 to 4; the neutral conductors ranging from 10 AWG to 8 AWG; and the insulated grounding conductor ranging from 12 AWG to 10 AWG as provided in Table 6, below:

TABLE 6

MC Cable with Oversized Neutral with Solid Conductors

| Conductors (AWG/No.) | Neutral conductor (AWG/No.) | Insulated Grounding Conductor (AWG/No) |
|---|---|---|
| 12/1, 12/2, 12/3 | 10/1 | 12/1 |
| 12/3 | 8/1 | 12/1 |
| 12/4 | 8/1, 10/1 | 12/1 |
| 10/1, 10/2, 10/3, 10/4 | 8/1 | 10/1 |

The cable having stranded conductors can include phase conductors ranging from 12 AWG to 10 AWG, with the number of phase conductors ranging from 1 to 4; the neutral conductors ranging from 10 AWG to 8 AWG; and the insulated grounding conductor ranging from 12 AWG to 10 AWG as provided in Table 7, below:

TABLE 7

MC Cable with Oversized Neutral with Stranded Conductors

| Conductors (AWG/No.) | Neutral conductor (AWG/No.) | Insulated Grounding conductor (AWG/No) |
|---|---|---|
| 12/1, 12/2, 12/3, 12/4 | 10/1 | 12/1 |
| 12/3 | 8/1 | 12/1 |
| 10/2, 10/3, 10/4 | 8/1 | 10/1 |

Another cable 310, illustrated in FIG. 5, which can be used, for example, in healthcare facilities can include solid or stranded conductors 14 wrapped in a tape 16, such as a polymeric tape, such as a polyester or a polyethylene tape, such as the polyester tape, a marker tape 24, an insulated grounding conductor 18, and a bare grounding/bonding wire 20 that is in continuous contact with the armor. The cables having solid conductors can include conductors ranging from 12 AWG to 10 AWG, with the number of conductors ranging from 2 to 4; the insulated grounding conductor ranging from 12 AWG to 10 AWG; and the bare grounding/bonding wire ranging from 10 AWG to 8 AWG.

Referring briefly to FIG. 5A, the wrap 16, e.g., tape is loosely wrapped around the conductors 14, 18, leaving the bare grounding/bonding wire 20 outside of the wrap/tape 16. In this manner the wrap/tape 16 does not apply a force on the bare grounding/bonding wire 20 to maintain the bare grounding/bonding wire 20 in contact with the armor 12. Rather, it is the placement of the bare grounding/bonding wire 20 relative to the conductors 14, 18 that maintains the bare grounding/bonding wire 20 in contact with the armor 12. In embodiments, the bare grounding/bonding wire 20 may be oversized so as to maintain continuous contact between the bare grounding/bonding wire 20 and the armor 12. Embodiments of this cable 310 are as provided in Table 8, below:

TABLE 8

Bare Grounding, Solid Healthcare MC

| Conductors (AWG/No.) | Insulated Grounding Conductor (AWG) | Aluminum bare grounding/bonding wire (AWG) |
|---|---|---|
| 12/2, 12/3, 12/4 | 12 | 10 |
| 10/2, 10/3, 10/4 | 10 | 8 |

The cables having stranded conductors can likewise include conductors ranging from 12 AWG to 10 AWG, with the number of conductors ranging from 2 to 4; the insulated grounding conductor ranging from 12 AWG to 10 AWG; and the bare grounding/bonding wire ranging from 10 AWG to 8 AWG; and as provided in Table 9, below:

TABLE 9

Bare Grounding, Stranded Healthcare MC

| Conductors (AWG/No.) | Insulated Grounding Conductor (AWG) | Bare Aluminum grounding/bonding wire (AWG) |
|---|---|---|
| 12/2, 12/3, 12/4 | 12 | 10 |
| 10/2, 10/3, 10/4 | 10 | 8 |

Another cable 410, illustrated in FIG. 6, can include solid or stranded conductors 14 wrapped in a tape 16, such as a paper tape, or a polymeric tape, such as a polyester or a polyethylene tape, such as the polyester tape, a marker tape 24, an insulated grounding conductor 18, and a bare grounding/bonding wire 20 that is in continuous contact with the armor 12. The cables having solid conductors can include conductors ranging from 14 AWG to 10 AWG, with the number of conductors ranging from 2 to 4; the insulated grounding conductor ranging from 14 AWG to 10 AWG; and the bare grounding/bonding wire, which can be a strip of 16 AWG.

As with the cable illustrated in FIG. 5, in this cable, the wrap 16, e.g., tape is loosely wrapped around the conductors 14, 18, leaving the bare grounding/bonding wire 20 outside of the wrap/tape 16. In this manner the wrap/tape 16 does not apply a force on the bare grounding/bonding wire 20 to maintain the bare grounding/bonding wire 20 in contact with the armor 12. Rather, it is the placement of the bare grounding/bonding wire 20 relative to the conductors 14, 18 that maintains the bare grounding/bonding wire 20 in contact with the armor 12. In embodiments, the bare grounding/bonding wire 20 may be oversized so as to maintain continuous contact between the bare grounding/bonding wire 20 and the armor 12. Embodiments of this cable are as provided in Table 10, below:

TABLE 10

Bare Grounding, Solid Healthcare AC

| Conductors (AWG/No.) | Insulated Grounding Conductor (AWG) | Aluminum grounding/bonding wire (AWG) |
|---|---|---|
| 14/2, 14/3, 14/4 | 14 | 16 |
| 12/2, 12/3, 12/4 | 12 | 16 |
| 10/2, 10/3, 10/4 | 10 | 16 |

The cables having stranded conductors can likewise include conductors ranging from 14 AWG to 10 AWG, with the number of conductors ranging from 2 to 4; the insulated grounding conductor ranging from 14 AWG to 10 AWG; and the bare grounding conductor, which can be a strip of 16 AWG, as provided in Table 11, below:

TABLE 11

Bare Grounding, Stranded Healthcare AC

| Conductors (AWG/No.) | Insulating Grounding Conductor (AWG) | Aluminum grounding/bonding wire (AWG) |
|---|---|---|
| 14/2, 14/3, 14/4 | 14 | 16 |
| 12/2, 12/3, 12/4 | 12 | 16 |

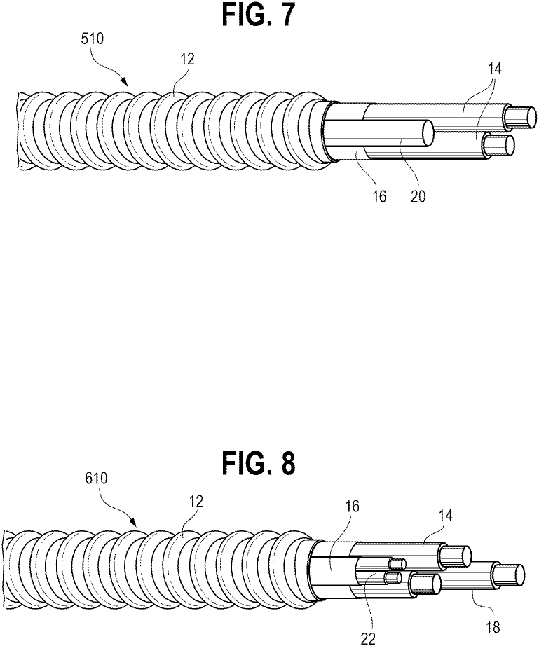

Another cable 510, illustrated in FIG. 7, can include solid or stranded conductors 14 wrapped in a tape or having a separator tape 16, such as a polymeric tape, such as a polyester or a polyethylene tape, such as the polyester tape and a bare grounding/bonding wire 20 that is in continuous contact with the armor 12. The cables having solid conductors can include conductors ranging from 14 AWG to 10 AWG, with the number of conductors ranging from 2 to 4 and the bare grounding conductor can range from 12 AWG to 8 AWG, as provided in Table 12, below:

TABLE 12

Bare Grounding, Solid All-Purpose MC

| Conductors (AWG/No.) | Aluminum grounding/bonding wire (AWG) |
|---|---|
| 14/2, 14/3, 14/4 | 12 |
| 12/2, 12/3, 12/4 | 10 |
| 10/2, 10/3, 10/4 | 8 |

The cables having stranded conductors can likewise include conductors ranging from 14 AWG to 10 AWG, with the number of conductors ranging from 2 to 4 and the bare grounding conductor can range from 12 AWG to 8 AWG, as provided in Table 13 below:

TABLE 13

Bare Grounding, Stranded All-Purpose MC

| Conductors (AWG/No.) | Aluminum grounding/bonding wire (AWG) |
|---|---|
| 14/2, 14/3, 14/4 | 12 |
| 12/2, 12/3, 12/4 | 10 |
| 10/2, 10/3, 10/4 | 8 |

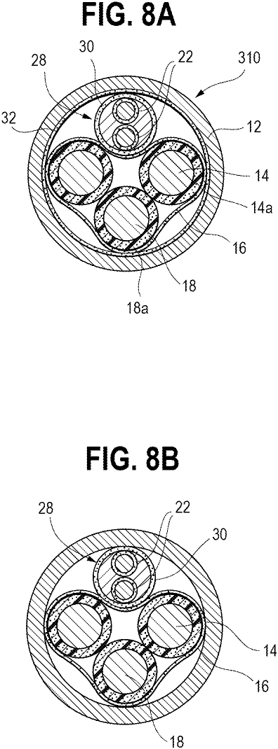

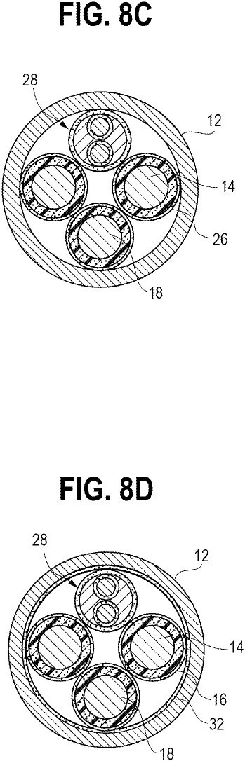

Still another cable 610 is illustrated in FIG. 8, and can include solid or stranded conductors 14, an insulated grounding conductor 18, control conductors 22 and a separator tape 16, for example, a wrapped tape. The cables having solid conductors can include conductors ranging from 12 AWG to 10 AWG, with the number of conductors ranging from 2 to 4; the insulated grounding conductor ranging from 12 AWG to 10 AWG; and solid control conductors of 16 AWG.

In these embodiments, the control conductors 22 are present within a subassembly 28. The illustrated control subassembly 28 includes a pair of insulated or jacketed control conductors 22; however, it will be understood that the control subassembly 28 may include more than one pair of control conductors.

The control subassembly 28 is positioned within a jacket 30. In these embodiments, the jacket 30 of the control subassembly 28 is not directly adjacent to (not in contact with) any of the power or insulated grounding conductor jackets 14a, 18a. That is, for any of the power and insulated grounding conductors 14, 18 adjacent to the control subassembly 22, the conductors’ binder 16 (whether the power and insulated grounding conductors are wrapped together as seen in FIGS. 8A and 8B, or individually wrapped as seen in FIGS. 8C and 8D), is disposed between the power and insulated grounding conductors 14, 18 and the control subassembly 28. Embodiments of these cables are as provided in Table 14, below:

TABLE 14

Control Solid Conductors

| Conductors (AWG/No.) | Insulated Grounding Conductor (AWG) | Control conductor (AWG) |
|---|---|---|
| 12/2, 12/3, 12/4 | 12 | 16/2 (solid) |
| 10/2, 10/3 | 10 | 16/2 (solid) |

The cables having stranded conductors can include conductors ranging from 12 AWG to 10 AWG, with the number of conductors ranging from 2 to 3; the insulated grounding conductor ranging from 12 AWG to 10 AWG; and solid control conductors of 16 AWG, as provided in Table 15, below:

TABLE 15

Control Stranded Conductors

| Conductors (AWG/No.) | Insulated Grounding Conductor (AWG) | Control conductor (AWG) |
|---|---|---|
| 12/2, 12/3 | 12 | 16/2 (solid) |
| 10/2 | 10 | 16/2 (solid) |

In these embodiments, as seen in FIG. 8A in which the conductors 14, 18 are wrapped together, the power and insulated grounding conductors 14, 18 and the control conductor subassembly 28 can be further wrapped by an additional wrap 32 together within the armor 12, or, as seen in FIG. 8D, in which the conductors 14, 18 are wrapped individually, the power and insulated grounding conductors 14, 18 and the control assembly 28 can be further wrapped by an additional wrap 32 together within the armor 12.

Those skilled in the art will appreciate that there are numerous codes that specify the requirements for the above-noted cables. The following lists some of the applicable codes:
Underwriters Laboratories (UL), UL1569 - Standard for Safety Metal-Clad Cables
UL2556 - Standard for Safety Wire and Cable Test Methods
UL83 - Thermoplastic-Insulated Wires and Cables
UL1581 - Standard for Safety Reference Standard for Electrical Wires, Cables, and Flexible Cords
UL1479 - Standard for Safety Fire Tests of Penetration Firestops
ASTM B800 - Standard Specification for 8000 Series Aluminum Alloy Wire for Electrical Purposes - Annealed and Intermediate Tempers
National Fire Protection Association (NFPA), NFPA 70 (National Electrical Code) Article 330 - Metal-Clad Cable Type MCI
NFPA 70 (National Electrical Code) Article 250 - Grounding & Bonding
NFPA 70 (National Electrical Code) Article 517 - Health Care Facilities
NFPA 70 (National Electrical Code) Article 725 - Class 1, Class 2, and Class 3 Remote-Control and Signaling Systems

It will be understood that the features from any one of the embodiments described above may be implemented in, combined or used together with, or replace features from any of the other embodiments described above.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular. In addition, it is understood that terminology referring to orientation of various components, such as “upper” or “lower” is used for the purposes of example only, and does not limit the subject matter of the present disclosure to a particular orientation.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover all such modifications as fall within the scope of the claims.

1. A metal clad cable comprising:
at least two power conductors each disposed within a first jacket;
a bare grounding/bonding wire;
a binder surrounding the at least two power conductors, the binder being loosely positioned around the at least two power conductors; and
a spiral wound metal cladding surrounding the at least two power conductors in the binder and the bare grounding/bonding wire,
wherein the bare grounding/bonding wire is positioned outside of the binder, between the binder and the spiral wound metal cladding and is in continuous contact with the spiral wound metal cladding, and
wherein the bare grounding/bonding wire is maintained in continuous contact with the spiral wound metal cladding by a force applied by at least one of the at least two power conductors on the bare grounding conductor, and
wherein a space is present between at least a portion of the binder and the bare grounding/bonding wire.

2. The metal clad cable of claim 1, wherein the binder is a polymeric material.

3. The metal clad cable of claim 2, wherein the polymeric material is a polyester tape.

4. The metal clad cable of claim 1, wherein the at least two power conductors is three power conductors, wherein the binder is positioned around the three power conductors, and wherein the bare grounding/bonding wire is outside of the binder, between the binder and the spiral wound metal cladding.

5. The metal clad cable of claim 1, wherein the at least two power conductors are 10 gauge or 12 gauge conductors and wherein the bare grounding/bonding wire is a 10 gauge or a 12 gauge conductor.

6. The metal clad cable of claim 1, wherein the at least two power conductors are solid conductors.

7. The metal clad cable of claim 1, wherein the at least two power conductors are stranded conductors.

8. The metal clad cable of claim 1 further including an insulated grounding conductor.

9. A metal clad cable comprising:
three power conductors each disposed within a first jacket;
a bare grounding/bonding wire;
a binder surrounding each of the three power conductors; and
a spiral wound metal cladding surrounding the three power conductors in their respective binders and the bare grounding/bonding wire,
wherein the bare grounding/bonding wire is positioned between two of the three power conductors and the spiral wound metal cladding and is in continuous contact with the spiral wound metal cladding, and is spaced from, and is not directly or indirectly in contact with, the third power conductor, and
wherein the bare grounding/bonding wire is maintained in continuous contact with the spiral wound metal cladding by a force applied by the two power conductors on the bare grounding/bonding wire.

10. The metal clad cable of claim 9, wherein the binder is a polymeric material.

11. The metal clad cable of claim 10, wherein the polymeric material is a polyester tape.

12. (canceled)

13. The metal clad cable of claim 9, wherein the three power conductors are 10 gauge or 12 gauge conductors and wherein the bare grounding/bonding wire is a 10 gauge or a 12 gauge conductor.

14. The metal clad cable of claim 13, wherein the three power conductors are solid conductors.

15. The metal clad cable of claim 13, wherein the three power conductors are stranded conductors.

16. The metal clad cable of claim 9 further including an insulated grounding conductor.

17. A metal clad cable comprising:
at least two power conductors each disposed within a first jacket;
a control subassembly comprising at least two control wires, each of the at least two control wires disposed in a second jacket;
a binder surrounding the at least two power conductors; and
a spiral wound metal cladding surrounding the at least two power conductors and the control subassembly,
wherein the control subassembly is outside of the binder.

18. The metal clad cable of claim 17, wherein the binder is a polymeric material.

19. The metal clad cable of claim 18, wherein the polymeric material is a polyester tape.

20. The metal clad cable of claim 17, wherein the binder is a first binder, and further including a second binder surrounding the at least two power conductors and the control subassembly.

21. The metal clad cable of claim 17 wherein the at least two power conductors is three power conductors.

22. (canceled)

23. The metal clad cable of claim 17, wherein the at least two power conductors are 10 gauge or 12 gauge conductors and wherein the control conductors are 16 gauge.

24. The metal clad cable of claim 23, wherein the at least two power conductors are solid conductors.

25. The metal clad cable of claim 23 wherein the at least two power conductors are stranded conductors.

26. The metal clad cable of claim 17 further including an insulated grounding conductor.

27. A metal clad cable comprising:
at least two power conductors each disposed within a first jacket;
a control subassembly comprising at least two control wires, each of the at least two control wires disposed in a second jacket;
a binder surrounding each of the at least two power conductors;
an insulated grounding conductor; and
a spiral wound metal cladding surrounding the at least two power conductors, the insulated grounding conductor and the control subassembly.

28. The metal clad cable of claim 27, wherein the binder a polymeric material.

29. The metal clad cable of claim 28, wherein the polymeric material is a polyester tape.

30. The metal clad cable of claim 29, wherein the at least two power conductors is three power conductors, wherein each of the three power conductors is disposed within its respective polymeric tape binder.

31. The metal clad cable of claim 27, further including a second binder surrounding the at least two power conductors and the control subassembly.

32. The metal clad cable of claim 27 wherein the at least two power conductors is three power conductors.

33. The metal clad cable of claim 32, further including a second wrap surrounding the wrapped three power conductors and the control subassembly.

34. The metal clad cable of claim 27, wherein the at least two power conductors are 10 gauge or 12 gauge conductors and wherein the control conductors are 16 gauge conductors.

35. The metal clad cable of claim 34, wherein the at least two power conductors are solid conductors.

36. The metal clad cable of claim 34 wherein the at least two power conductors are stranded conductors.

37. (canceled)
